(19) United States
(12) Patent Application Publication
(10) Pub. No.: US 2004/0240433 A1
(43) Pub. Date: Dec. 2, 2004

(54) Method for desensitizing packet-based connection of subscribers to a switching system

(76) Inventor: Norbert Lobig, Darmstadt (DE)

Correspondence Address: Siemens Corporation, Intellectual Property Department, 170 Wood Avenue South, Iselin, NJ, 08830, US

(21) Appl. No.: 10/491,037

(22) PCT Filed: Sep. 10, 2002
(86) PCT No.: PCT/DE02/03355

(30) Foreign Application Priority Data
Sep. 27, 2001 (DE) 10147771.6

(51) Int. Cl. H04L 12/66; H04L 12/28; H04L 12/56

(52) U.S. Cl. 370/352; 370/401

(57) ABSTRACT

The invention relates to a method for the protection of a packet network switching system from an overload due to defective or manipulated packets. According to the inventive method, the format of the incoming packets in the packet network switching system is verified. If a threshold value for the throughput of packets with an incorrect format is exceeded, the network administration receives an alarm. The disruption of the units affected by the overload can be eliminated by the network administration of the packet network switching system by allocating new packet addresses. The method advantageously avoids disruptions occurring in the switching process in the packet network by defending against overload. Preferably, the packet network switching network consists of a PSTN switching system.

### CROSS REFERENCE TO RELATED APPLICATIONS

This application is the US National Stage of International Application No. PCT/DE02/03355, filed Sep. 10, 2002 and claims the benefit thereof. The International Application claims the benefits of German application No. 10147771.6 DE filed Sep. 27, 2001, both of the applications are incorporated by reference herein in their entirety.

### FIELD OF INVENTION

The invention relates to a method for monitoring a packet network switching system for overloads due to defective or manipulated packets.

### BACKGROUND OF INVENTION

In circuit-switched telephony, for which the acronym PSTN (public switched telephone network) is used, subscribers in the public switched telephone network are connected via lines to the public switching systems that are assigned to them or that are responsible for them. Subscriber line concentrators or subscriber access networks—often known simply as access networks—may be installed upstream of the switching system and enable subscriber lines to be grouped, the result of which however is still the circuit-based connection of the switched subscriber to the switching system. Grouping of the subscriber lines is generally implemented with the aid of time-division multiplexing, such as PCM (Pulse Code Modulation) or SDH (Synchronous Digital Hierarchy).

With the increase in services based on variable bit rates, subscribers to the public switched telephone network have increasing access to packet networks, namely access to the internet via broadband transmission networks such as LANs (Local Area Networks), networks with DSLs (Digital Subscriber Lines) or cable networks. For subscribers with access to a packet network it makes sense to use the lines or networks needed for packet-based access also for telephone traffic instead of maintaining separate narrow-band lines/networks for telephony.

For PSTN subscribers accessing a packet-based network there are subscriber-related network access equipment such as IADs (Integrated Access Devices) or cable modems that provide the termination for the subscriber-side transmission network, e.g. LAN, network with DSL peripherals or cable network. On the subscriber side, such network access devices have analog or ISDN (Integrated Services Digital Network) lines; on the packet network side, telephony signaling and user data is transmitted with certain security protocols.

There are also packet-based terminals, such as telephones based on the internet protocol (IP), with signaling protocols defined specifically for use in the packet network, such as the H.323 Standard defined by the International Telecommunications Union (ITU) or SIP (Session Initiation Protocol) defined by IETF.

In setting up connections for telephone calls, for example, via packet networks a control device is generally involved—henceforth referred to as a packet network switching system—which performs for example the functions of access control, signaling, connection control and billing. A central function of such a packet network switching system is call number assignment, needed for access to the public network (according to the E.164 numbering plan in the international network), to the IP address valid for packet network transmission for a PSTN telephone call transferred via a packet network. This packet network switching system may for example include an appropriately equipped server in the IP network—often referred to as a gatekeeper—or a PSTN switching system equipped for these additional packet network related functions. In addition, decentralized resources may be provided for control or monitoring functions in the network access devices. It is assumed below that the packet network switching system includes a central computing and control unit and is referred to as a packet exchange.

For efficient performance of the control and switching functions of the control device it is important to protect the control device from switching overload. An overload may occur for example if data packets are transferred to the control device by defective or manipulated terminals at an excessively high rate. In view of the high quality requirements for voice transmission and the need for small delay times, such overloads or disruptions may lead to an impairment of the functionality of the control device for voice transmission.

From PSTN switching engineering a method is known in which overloads caused by ISDN (Integrated Services Digital Network) lines in a PSTN switching sys tern are restricted. The method is used for the standard V 5.2 interface of an exchange to the access network and has been standardized as the “D-Channel Blocking/Unblocking” feature of the V 5.2 interface by ETSI (European Telecommunications Standards Institute) under number ETS 300347. With this method a PSTN switching system can identify the line (usually referred to as a port) responsible for the overload and block or unblock the relevant signaling channel (D channel) with commands to the upstream access network with a V 5.2 interface.

### SUMMARY OF INVENTION

The object of the invention is to define a method for packet networks by which control devices are monitored for overloads caused by defective or manipulated packets and which helps prevent disruptions in control devices due to such overloads.

This object is achieved by the characteristic features of the method described in the precharacterizing clause of claim 1.

In the method according to the invention, the throughput of the incoming packets in the packet network switching system is checked. If a threshold value for the throughput of packets is exceeded the network administration receives an alarm, and the network administration performs validity checks on the originating addresses of the packets (claim 1). The method has the advantage of controlling or checking for overloads due to signaling packets transferred to the packet network switching system. Counter-measures can be taken in the event of an overload.

One possible counter-measure is to prevent an overload by reassigning packet addresses. The format or parts of the content of the incoming packets in the packet network switching system are checked and packets with an incorrect format or incorrect contents are statistically recorded. If a threshold value for the throughput of packets with an incorrect format or incorrect contents is exceeded, network administration receives an alarm and allocates new packet addresses to the units of the packet network switching system affected by the overload (claim 2 or claim 3). The solution involving the reassignment of packet addresses is of particular importance. This solution prevents disruptions due to overloads of packets with an incorrect format.

Packet network access devices often also provide control or switching functions and may include part of a decentralized switching system. Overloads for packet network access devices may therefore jeopardize proper data transfer. According to the invention a packet network access device is protected against overload by checking the format or parts of the content of the incoming packets for a packet network access unit in the area of responsibility of the packet network switching system. Packets with an incorrect format or incorrect contents are statistically recorded. If a threshold value for the throughput of packets with an incorrect format or incorrect contents is exceeded in the packet network access unit the network administration receives an alarm and allocates new packet addresses to the network access units or ports affected by the overload. In addition, the packet network switching system and devices arranged between the packet network exchange and the network access unit are set up to use the reassigned packet address (claim 4).

The overall throughput of packets and the throughput of packets with incorrect formats or contents in the packet network exchange or the network access units are checked at regular intervals (claim 5) so that changes in the load due to packets with incorrect formats or contents can be monitored.

Packets arriving at the packet network switching system or the network access units are checked for the correctness of the originating address, the port references and the packet format (claim 6). In addition to the packet format, the originating address and the port number are important in identifying disrupting units or disrupting applications. In the latter case, this may be an application to which a port number has been assigned in the TCP protocol.

To protect packets from disruptive influences, new packet addresses are entered in the routing tables of the units of the packet network switching system, the network access units and routers in the area of responsibility of the packet network switching system that are

affected by the change of packet addresses (claim 8). By adapting the routing tables of the relevant units of the packet network switching system, network access units and—if available—routers, packets from disrupting influences are rerouted or rejected.

An appropriate change in the routing tables may be made for example during a system restart.

Ports identified as defective are alarmed for the purposes of fault clearance (claim 10). As soon as a disruption occurs due to defective ports the appropriate ports are blocked or the settings of the packet network switching system and network access units are changed so that packets arriving from the ports are rejected (claim 11). Blocked ports that are identified as defective are unblocked at regular intervals: In the course of unblocking, checks are carried out on the packets transferred by the port and if the port is found to be functioning correctly it is put back into switching service (claim 12). In this way, defective ports can be blocked and—if the problem is resolved—unblocked again, which provides protection against overloads and at the same time ensures minimal intervention in switching operations. The solution involving blocks on defective ports is of particular importance.

With the aid of this method it is possible to protect a packet network switching system embodied by a PSTN switching system.

For the packet network switching system, packet adaptation units are provided to adapt to the physical interfaces of the packet network, to packet-based addressing and packet-based signaling protocols, and

the PSTN switching system is embodied with line/trunk groups (claim 14). In the method according to the invention, packets arriving at the packet adaptation units of the switching system are adapted for forwarding to the line/trunk groups and forwarded to the line/trunk groups. In the line/trunk groups the packets forwarded by the packet adaptation units are checked with the aid of checking features available as part of the functions of the PSTN switching system and counter-measures available as part of the functions of the PSTN switching system are taken in the event of a fault (claim 15). It is advantageous here that the available functionality of the PSTN switching system can be used. For example, the fault clearance functions provided in the PSTN switching system may include D-channel blocking/unblocking as defined in the V5.2 standard (claim 16).

Further beneficial embodiments of the invention are given in the subclaims.

### BRIEF DESCRIPTION OF THE DRAWINGS

The invention is presented on the basis of two exemplary embodiments. The figures show the following:

FIG. 1: Classic and packet-based subscribers connected to a packet-based exchange,

FIG. 2: Exchange adapted for packet processing, to which a network access device is connected.

Identical elements are labeled with the same reference characters.

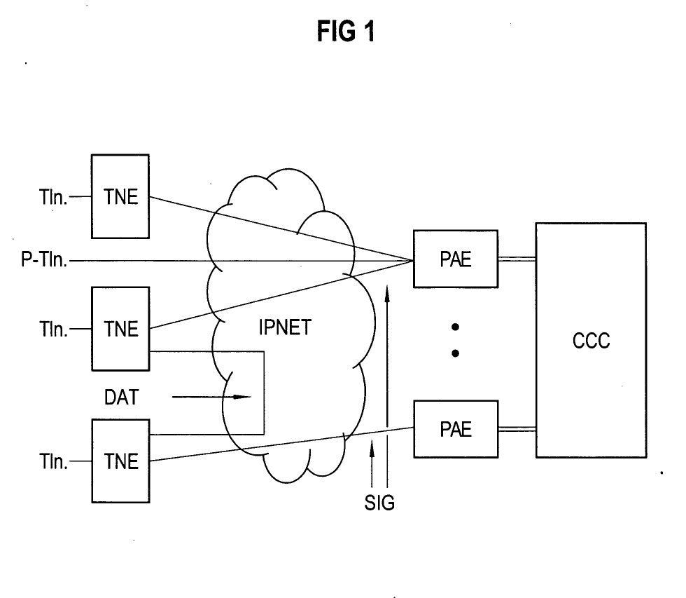

FIG. 1 shows a control unit (CCC: Call Control Core) of a PSTN exchange that has been equipped with packet adaptation units PAE for signaling, control and monitoring tasks in the packet network IPNET. For setting up connections, such as telephone calls, via the packet network IPNET, signaling information is transferred from the relevant subscriber lines to the packet adaptation units PAE of the exchange. These may be PSTN lines/subscribers connected to the packet network via network access units TNE or packet-based P subscribers connected directly to the packet network and equipped with terminals supporting a voice function. While signaling information SIG is routed via the exchange, user data DAT is exchanged directly via the packet network between the network access devices TNE or IP terminals of packet-based P subscribers. With the method as per the invention, the packet adaptation units PAE are protected from an overload of signaling information SIG. For example, signaling information SIG arrives at packet adaptation unit PAE at a high rate from a network access device TNE due to a fault. With this signaling information SIG from the network access device TNE the signaling SIG for other connections or subscriber terminals, which may have to meet availability and quality requirements for voice transmission, is disrupted. In the packet adaptation equipment PAE the messages transferred from the network access devices TNE are check ed for correct addresses, port references and message format. These checks may for example indicate that the messages transferred from the disrupted network access device TNE have an incorrect format. Network administration is then informed of the fault by the exchange. Network administration then initiates changes of addresses to clear the fault. For example, the disrupting network access unit TNE may be given a new packet network address in TNE and PAE, which means that the disrupting messages arriving at the packet network adaptation equipment PAE are rejected.

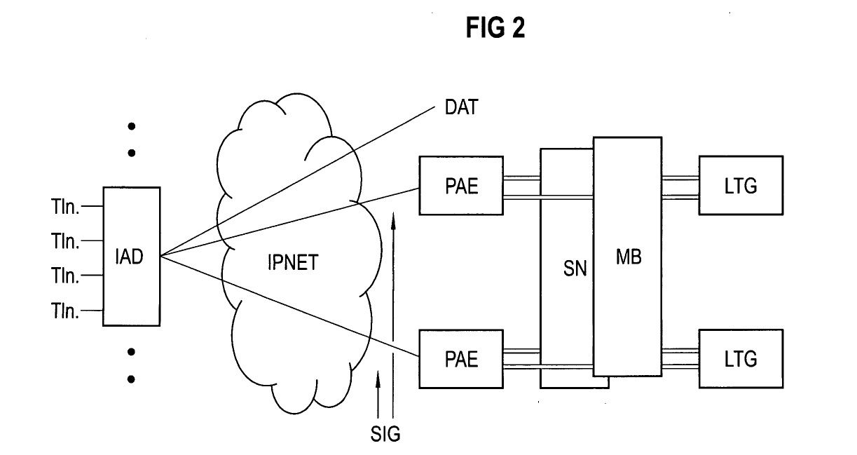

In the second embodiment (FIG. 2) a number of PSTN telephony subscribers Tln are connected via XDSL routes and a network access device IAD (IAD: Integrated Access Device) to a switching system which is equipped with packet adaptation units PAE for signaling the data traffic handled via the packet network IPNET. In addition, the switching system has a switching network SN, a message distribution system MB and line/trunk groups LTG. The packet network IPNET is a network based on the internet protocol. User data DAT is exchanged directly between the network access device IAD and another network access device TNE or an IP terminal. Subscriber signaling is handled via the switching system. For example, due to a disrupted port too many messages per time unit are transferred to the network adaptation unit PAE. These fault-related messages are detected in the network access device IAD or in the packet adaptation equipment PAE by means of threshold value monitoring. For fault clearance, network management receives an alarm. Network management sends a message to the packet adaptation unit PAE for blocking the disrupted port, which in turn means that the line/trunk group LTG and therefore the control units of the switching system are notified. The switching system then configures the relevant port to put it out of operation. If the behavior of the port normalizes again, this is detected by the network access device IAD and signaled to the switching system. The switching system then puts the port back in operation.

For a defective ISDN port on the IAD, the D-channel blocking/unblocking function of an ISDN switching system as defined in the V5.2 standard may be used. In this case, the D channel messages of the disrupted port on the network access device IAD are routed via the stream control transmission protocol (SCTP) to the packet adaptation unit PAE and forwarded there to the message line/trunk groups LTG. In the subscriber line/trunk groups LTG, the statistical method for V5.2 can then be applied to the D channel messages or signaling information of the port. If there are too many messages per time unit a block on the port is initiated, which is reported to the packet network adaptation unit TAE and leads to rejection of the incoming messages from the disrupted port. After a certain recovery time the port of the message line/trunk group in the packet adaptation unit PAE is unblocked so that the behavior of the port can be checked. The port is then blocked again if its behavior has not yet normalized. Otherwise, an end-of-fault message is sent to network management and the port is automatically put back in operation.

1-18. (canceled).

19. A method for monitoring a packet network switching system having a central computing unit that controls a connection setup for telephone calls via a packet network, comprising:
checking a throughput of incoming packets through the packet network switching system;
alarming a network administration if a threshold value for the throughput of packets is exceeded; and
performing a validity check on an originating address of the incoming packets by the network administration.

20. The method according to claim 19, further comprising:
checking a format of the incoming packets;
statistically recording the packets having an incorrect format;
alarming a network administration if a threshold value for the throughput of packets with an incorrect format is exceeded; and
allocating new packet addresses to units of the packet network switching system affected by the threshold value overload.

21. The method according to claim 19, further comprising:
checking portions of the incoming packets;
statistically recording the packets with incorrect contents;
alarming a network administration if a threshold value for the throughput of packets with incorrect contents is exceeded; and
allocating new packet addresses to units of the packet network switching system affected by the threshold value overload.

22. The method according to claim 19, further comprising:
checking the incoming packets for a packet network access unit within an area of responsibility of the packet network switching system;
statistically recording the packets with an incorrect format or incorrect contents;
alarming a network administration if a threshold value for the throughput of packets with the incorrect format or incorrect contents is exceeded;
allocating new packet addresses to units of the network access switching system affected by the threshold value overload; and
using the reassigned packed address within the packet network switching system.

23. The method according to claim 19, wherein the overall throughput of packets and the throughput of packets with incorrect formats or contents in the packet network exchange or network access units are checked at regular intervals.

24. The method according to claim 23, wherein the packets arriving at the packet network switching system or the network access units are checked for correctness of an originating address, a port reference and a packet format.

25. The method according to claim 24, wherein the packets identified as being defective in the packet network switching system or network access units are rejected.

26. The method according to claim 25, wherein new packet addresses are entered in routing tables of units of the packet network switching system.

27. The method according to claim 26, wherein at least a portion of the address changes is made by symbolic addressing.

28. The method according to claim 27, wherein ports from where the packets were transferred are identified when the packets are checked, and ports identified as defective are alarmed for the purposes of fault clearance.

29. The method according to claim 28, wherein characterized in that ports identified as defective are blocked or settings for functionality of the packet network switching system and network access units are changed so that the packets arriving from the ports are rejected.

30. The method according to claim 28, wherein ports identified and blocked as defective are unblocked at certain intervals, the packets transferred by the port are checked during unblocking, and ports functioning correctly are put back into the switching operation.

31. The method according to claim 19, wherein the packet network is a network based on an internet protocol.

32. The method according to claim 19, wherein the packet network switching system is a PSTN switching system having line/trunk groups in which packet adaptation units adapt to physical interfaces of the packet network, to packet-based addressing and to packet-based signaling protocols.

33. The method according to claim 32, wherein the packets arriving at the packet adaptation units are forwarded to the line/trunk group and the packets are checked by the PSTN switching system, and counter-measures are provided in the event of a fault by the PSTN switching system.

34. The method according to claim 33, wherein the fault clearance functions provided in the PSTN switching system involves D-channel blocking/unblocking as defined in the V5.2 standard.

35. The method according to claim 19, wherein one of the network access units is an integrated access device or an access gateway for terminating PSTN/ISDN telephone lines and adapting the telephony data for the packet network and the gateway control protocol or H.248 is used for signaling between the network access unit and the packet network switching system.

36. The method according to claim 33, wherein the functions of packet adaptation units and the line/trunk groups are made available on a common peripheral hardware platform of the switching system.
